(19) United States
(12) Patent Application Publication
(10) Pub. No.: US 2017/0372403 A1
(43) Pub. Date: Dec. 28, 2017

(54) SYSTEMS AND METHODS FOR PROVIDING COMPLEMENTARY PRODUCT SUGGESTIONS

(71) Applicant: CAPITAL ONE SERVICES, LLC, McLean, VA (US)

(72) Inventors: Hannes Jouhikainen, Arlington, VA (US); Drew Jacobs, Arlington, VA (US)

(21) Appl. No.: 15/626,841

(22) Filed: Jun. 19, 2017

Related U.S. Application Data
(60) Provisional application No. 62/353,933, filed on Jun. 23, 2016.

(51) Int. Cl. G06Q 30/06; G06Q 20/20

(52) U.S. Cl. CPC G06Q 30/0631; G06Q 20/202

(57) ABSTRACT

A system includes one or more memory devices storing instructions, and one or more processors configured to execute the instructions to perform steps of a method. The system may provide complementary product suggestions to a consumer. The system may receive a listing of purchased products, and determine whether any of the purchased products on the listing correspond to one or more predetermined complementary product sets. The system may then identify one or more unpurchased products from the one or more complementary product sets. The system can then notify the consumer of the identified unpurchased products that they may want to purchase.

### CROSS-REFERENCE TO RELATED APPLICATIONS

This application claims the benefit of U.S. Provisional Application No. 62/353,933, filed 23 Jun. 2016, the entire contents and substance of which is hereby incorporated by reference.

### FIELD OF INVENTION

The present disclosure relates to systems and methods for providing one or more users with suggestions for products that complement products purchased or to be purchased by the user.

### BACKGROUND

Certain items are intended to be purchased in groups. For example, a videogame console may be intended to be purchased with a videogame, or a flashlight may be intended to be purchased with batteries. Other items may have additional utility when purchased in groups. For example, a videogame console may be used for multiplayer gaming if purchased with an additional controller, or a personal computer may require an external drive for additional storage or media reading. Still other items may simply be typically or customarily purchased together. For example, a dress shirt may often be purchased with a tie, or complementary food items may be purchased together; such as peanut butter and jelly. These complementary items may improve the consumer experience or avoid multiple trips to a retailer.

The shopper may either forget or simply not be aware of complementary products that may enable or improve the use of other products to be purchased. Finding out on Christmas morning that the video game console purchased for children only comes with a single controller, or that a toy does not come with batteries is a potential disaster for a gift-giver. Going to the store to purchase an outfit for an event, but forgetting a belt or other accessory may result in having to use a less appropriate or non-matched item. Buying cereal and forgetting milk, or buying the ingredients for a recipe but forgetting one, may result in a second trip to the store. These issues and many more can be avoided by simply making a shopper aware of these complementary items.

Accordingly, there is a need for systems and methods that notify or prompt a consumer of complementary products that may improve or supplement the products already purchased, or to be purchased. Embodiments of the present disclosure are directed to this and other considerations.

### SUMMARY

Disclosed embodiments provide systems and methods for providing complementary product suggestions.

Consistent with the disclosed embodiments, the system may include one or more memory devices storing instructions, and one or more processors configured to execute the instructions to perform steps of a method to provide complementary product suggestions. The system may execute the instructions to receive product data representing a listing of purchased products. The system may then determine whether any of the purchased products on the listing correspond to one or more predetermined complementary product sets. The one or more processors may then identify, for at least one of the purchased products corresponding to one or more of the predetermined complementary product sets, one or more unpurchased products from the one or more complementary product sets. Having determined the unpurchased products that may complete the complementary product sets, the system may provide, to a computing device such as a mobile device or merchant terminal, a notification of the one or more identified unpurchased products.

Consistent with the disclosed embodiments, methods for providing complementary product suggestions are also provided.

Further features of the disclosed design, and the advantages offered thereby, are explained in greater detail hereinafter with reference to specific embodiments illustrated in the accompanying drawings, wherein like elements are indicated be like reference designators.

### BRIEF DESCRIPTION OF THE DRAWINGS

Reference will now be made to the accompanying drawings, which are not necessarily drawn to scale, and which are incorporated into and constitute a portion of this disclosure, illustrate various implementations and aspects of the disclosed technology and, together with the description, serve to explain the principles of the disclosed technology. In the drawings:

FIG. 1 is a diagram of an exemplary system that may be used to suggest complementary products;

FIG. 2 is a component diagram of an exemplary financial service provider terminal;

FIG. 3 is a flowchart of an exemplary method for suggesting complementary products;

FIG. 4 is a diagram of an exemplary product data acquisition system;

FIG. 5 is a diagram of an exemplary complementary product set input process;

FIG. 6 is a diagram of an exemplary user notification system.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The disclosed embodiments are directed to systems and methods for providing complementary product suggestions. The system may include one or more memory devices storing instructions, and one or more processors configured to execute the instructions to perform steps of a method. Specifically, in some embodiments, the system may notify a consumer of a complementary product. To accomplish this, the system may execute the instructions to receive product data representing a listing of purchased products. As used herein, purchased products may also include those selected but not yet purchased, such as those in a physical or virtual shopping cart. The system may then determine whether any of the purchased products on the listing correspond to one or more predetermined complementary product sets. The one or more processors may then identify, for at least one of the purchased products corresponding to one or more of the predetermined complementary product sets, one or more unpurchased products from the one or more complementary product sets. Having determined the unpurchased products that may complete the complementary product sets, the system may provide, to a computing device such as a mobile device or merchant terminal, a notification of the one or more identified unpurchased products.

In another aspect, a non-transitory computer-readable medium storing instructions is disclosed. The instructions, when executed by one or more processors, may cause a computing device to perform steps of a method for notifying a consumer of a complementary product. Specifically, the computing device may receive product data comprising a listing of purchased products. The computing device may then determine whether any of the purchased products on the listing correspond to one or more predetermined complementary product sets. This determination may result in the identification of one or more unpurchased products from the one or more complementary product sets. The instructions may then cause the computing device to provide, to a mobile computing device, a notification of the one or more identified unpurchased products, thereby alerting the consumer.

In yet another respect, a system for obtaining complementary product suggestions is disclosed. The system may include one or more memory devices storing instructions, and one or more processors configured to execute those instructions. The instructions may cause the system to provide, via a mobile computing device, product data comprising a listing of purchased products. After sending the product data, the system may receive, on the mobile computing device, a notification of one or more unpurchased products based on the provided product data. The notification can include product purchase data associated with the one or more unpurchased products, and the unpurchased products can be any products in one or more predetermined complementary product sets that are not already included in the provided product data. The system may then provide for the purchase, via the mobile computing device, of one or more of the unpurchased products.

Reference will not be made in detail to exemplary embodiments of the disclosed technology, examples of which are illustrated in the accompanying drawings and disclosed herein. Wherever convenient, the same references numbers will be used throughout the drawings to refer to the same or like parts.

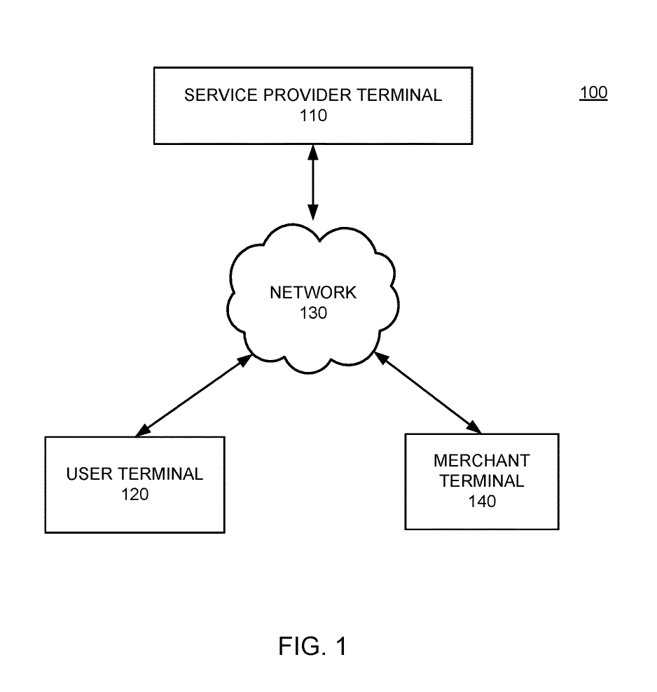

FIG. 1 is a diagram of an exemplary system that may be configured to perform one or more processes that can notify a consumer of complementary product. The components and arrangements shown in FIG. 1 are not intended to limit the disclosed embodiments as the components used to implement the disclosed processes and features may vary.

In accordance with disclosed embodiments, complementary product suggestion system 100 may include a service provider terminal 110 in communication with a user terminal 120 via network 130. In some embodiments, service provider terminal 110 is also in communication with a merchant terminal 140 via network 130. User terminal 110 may be a mobile computing device (e.g., a smart phone, tablet computer, smart wearable device, or portable laptop computer) or a stationary computing device (e.g., a stationary desktop or laptop computer). User terminal 110 may belong to or be provided by a consumer, or may be borrowed, rented, or shared.

Network 130 may be of any suitable type, including individual connections via the internet such as cellular or WiFi networks. In some embodiments, network 130 may connect terminals using direct connections such as radio-frequency identification (RFID), near-field communication (NFC), Bluetooth®, low-energy Bluetooth® (BLE), WiFi™, ZigBee®, ambient backscatter communications (ABC) protocols, USB, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

Merchant terminal 140 may be a point-of-sale (POS) terminal, a consumer database, any other suitable repository of purchase data, and/or display visible to an employee or the consumer. Merchant terminal 140 may send information via network 130 to service provider terminal 110, and/or merchant terminal 140 may receive information from service provider terminal 110 via network 130 to be displayed or otherwise conveyed to the consumer.

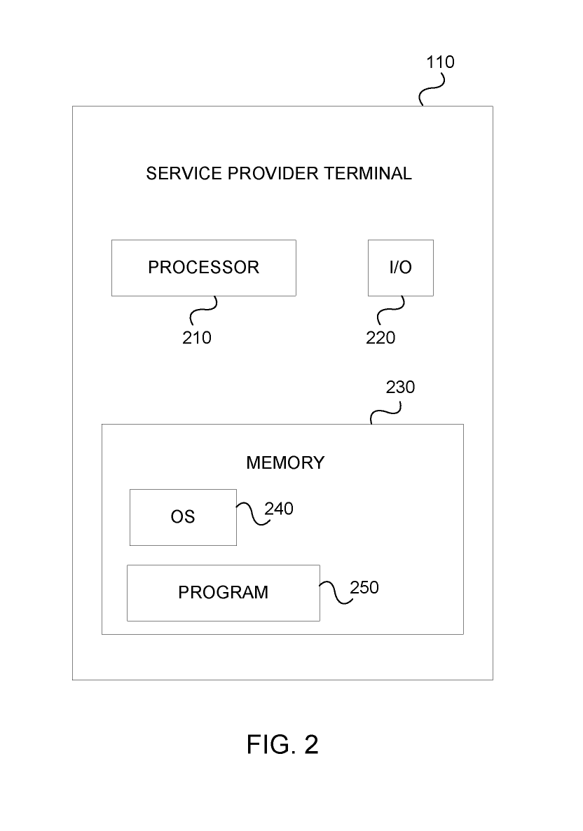

An embodiment of service provider terminal 110 is shown in more detail in FIG. 2. User terminal 120 and merchant terminal 140 may have a similar structure and components that are similar to those described with respect to service provider terminal 110. As shown, service provider terminal 110 may include a processor 210, an input/output (“I/O”) device 220, a memory 230 containing an operating system (“OS”) 240 and a program 250. For example, service provider terminal 110 may be a single server or may be configured as a distributed computer system including multiple servers or computers that interoperate to perform one or more of the processes and functionalities associated with the disclosed embodiments. In some embodiments, the service provider terminal 110 may further include a peripheral interface, a transceiver, a mobile network interface in communication with the processor 210, a bus configured to facilitate communication between the various components of the service provider terminal 110, and a power source configured to power one or more components of the service provider terminal 110.

A peripheral interface may include the hardware, firmware and/or software that enables communication with various peripheral devices, such as media drives (e.g., magnetic disk, solid state, or optical disk drives), other processing devices, or any other input source used in connection with the instant techniques. In some embodiments, a peripheral interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth®, low-energy Bluetooth® (BLE), WiFi™, ZigBee®, ambient backscatter communications (ABC) protocols or similar technologies.

A mobile network interface may provide access to a cellular network, the Internet, or another wide-area network. In some embodiments, a mobile network interface may include hardware, firmware, and/or software that allows the processor(s) 210 to communicate with other devices via wired or wireless networks, whether local or wide area, private or public, as known in the art. A power source may be configured to provide an appropriate alternating current (AC) or direct current (DC) to power components.

Processor 210 may include one or more of a microprocessor, microcontroller, digital signal processor, co-processor or the like or combinations thereof capable of executing stored instructions and operating upon stored data. Memory 230 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein are implemented as a combination of executable instructions and data within the memory 230.

Processor 210 may be one or more known processing devices, such as a microprocessor from the Pentium™ family manufactured by Intel™ or the Turion™ family manufactured by AMD™. Processor 210 may constitute a single core or multiple core processor that executes parallel processes simultaneously. For example, processor 210 may be a single core processor that is configured with virtual processing technologies. In certain embodiments, processor 210 may use logical processors to simultaneously execute and control multiple processes. Processor 210 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

Service provider terminal 110 may include one or more storage devices configured to store information used by processor 210 (or other components) to perform certain functions related to the disclosed embodiments. In one example, service provider terminal 110 may include memory 230 that includes instructions to enable processor 210 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, service provider terminal 110 includes memory 230 that includes instructions that, when executed by processor 210, perform one or more processes consistent with the functionalities disclosed herein. Methods, systems, and articles of manufacture consistent with disclosed embodiments are not limited to separate programs or computers configured to perform dedicated tasks. For example, service provider terminal 110 may include memory 230 that may include one or more programs 250 to perform one or more functions of the disclosed embodiments. Moreover, processor 210 may execute one or more programs 250 located remotely from system 100. For example, system 100 may access one or more remote programs 250, that, when executed, perform functions related to disclosed embodiments.

Memory 230 may include one or more memory devices that store data and instructions used to perform one or more features of the disclosed embodiments. Memory 230 may also include any combination of one or more databases controlled by memory controller devices (e.g., server(s), etc.) or software, such as document management systems, Microsoft SQL databases, SharePoint databases, Oracle™ databases, Sybase™ databases, or other relational databases. Memory 230 may include software components that, when executed by processor 210, perform one or more processes consistent with the disclosed embodiments.

Service provider terminal 110 may also be communicatively connected to one or more memory devices (e.g., databases (not shown)) locally or through a network. The remote memory devices may be configured to store information and may be accessed and/or managed by service provider terminal 110. By way of example, the remote memory devices may be document management systems, Microsoft SQL database, SharePoint databases, Oracle™ databases, Sybase™ databases, or other relational databases. Systems and methods consistent with disclosed embodiments, however, are not limited to separate databases or even to the use of a database.

Service provider terminal 110 may also include one or more I/O devices 220 that may comprise one or more interfaces for receiving signals or input from devices and providing signals or output to one or more devices that allow data to be received and/or transmitted by service provider terminal 110. For example, service provider terminal 110 may include interface components, which may provide interfaces to one or more input devices, such as one or more keyboards, mouse devices, touch screens, track pads, trackballs, scroll wheels, digital cameras, microphones, sensors, and the like, that enable service provider terminal 110 to receive data from one or more users (such as via user terminal 120).

In exemplary embodiments of the disclosed technology, the service provider terminal 110 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While the service provider terminal 110 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of the terminal 110 may include a greater or lesser number of components than those illustrated.

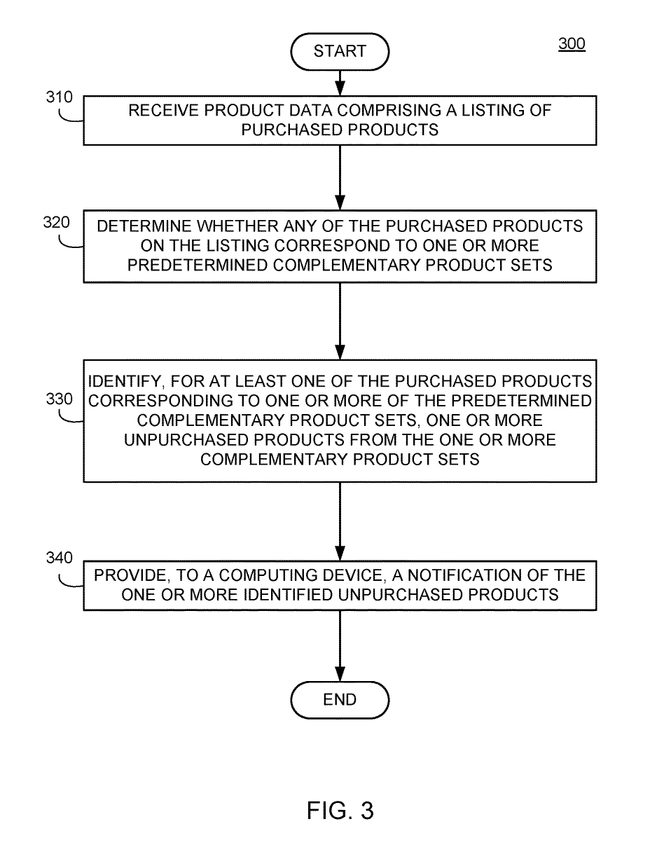

FIG. 3 shows a flowchart of method 300 for providing suggestions for complementary products to a user. Method 300 may be performed by service provider terminal 110 using processor 210 to execute memory 230. Following method 300, the user may continue to purchase one or more identified complementary products.

In block 310, service provider terminal 110 may receive product data comprising a listing of purchased products (e.g. via user terminal 120 or merchant terminal 140). At step 320, service provider terminal 110 may determine whether any of the purchased products on the listing correspond to one or more predetermined complementary product sets. The predetermined complementary products sets may be stored in memory 230, and may be inputted via I/O device 220.

In block 330, service provider terminal 110 may identify one or more unpurchased products from the one or more complementary product sets. These identified unpurchased products may complete one or more of the complementary product sets in combination with one or more of the purchased products. Once these unpurchased products have been identified, at step 340 service provider terminal 110 may provide a notification of the one or more unpurchased complementary products to a computing device (e.g. user terminal 120 or merchant terminal 140). As a result of steps 310-340, a user can receive a notification that may alert them to an identified unpurchased product that may complement those already purchased or to be purchased. At this point the user may elect to purchase the identified unpurchased product (e.g., in person at the POS location or at another merchant location, online via user terminal 120, etc.).

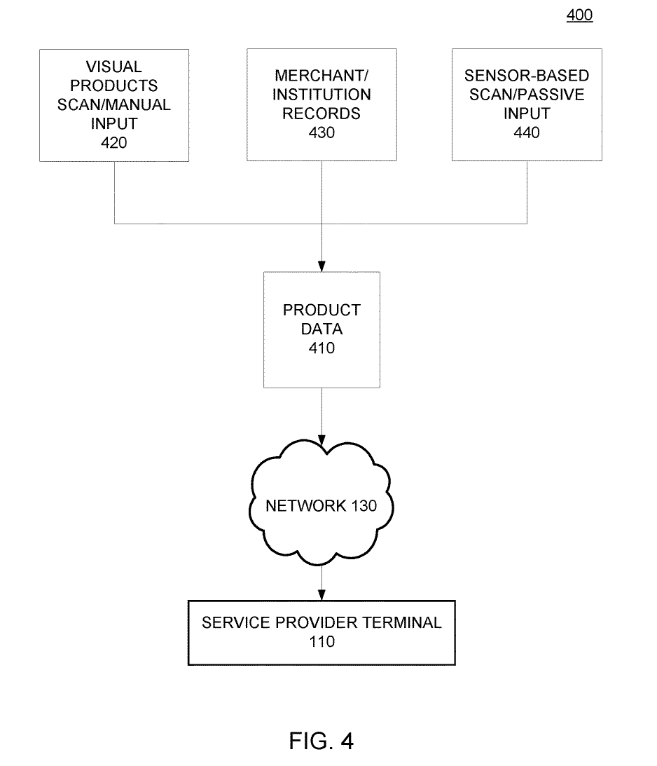

FIG. 4 shows a diagram that represents an embodiment of product data acquisition system 400. As discussed above with regard to step 310, service provider terminal 110 receives product data 410 via network 130 (e.g., from one or more of user terminal 120 and merchant terminal 140). Product data 410 may be a listing of purchased products, owned products, or products selected but not yet purchased (e.g., in a shopping cart or wish list). There are many methods of collecting product data 410, and FIG. 4 shows three exemplary sources of product data.

Box 420 represents visual products scanning/manual input of purchased items. A user may enter products by name, scan barcodes on the product packaging, take a picture of a receipt, or any other suitable method of inputting product data. Product data 410 associated with the products may be entered, for example, via user terminal 120 or merchant terminal 140. In some embodiments, a mobile or web-based application may allow a user's device (e.g., user terminal 120) to be used as a barcode scanner or data entry device. Alternatively or additionally, a merchant may provide a scanner or other imaging devices to scan items during the shopping process, and the scanner or other imaging devices may be in communication with user terminal 120 and/or merchant terminal 140. In some embodiments, the user may take a picture of a product or a group of products using a mobile device (e.g., user terminal 120 or a cameria/imaging device in communication therewith), and an application on the mobile device or on the service provider terminal 110 may visually identify the products.

Box 430 represents merchant (or other institution) records, which may be stored at and/or collected via merchant terminal 140. These records may be incorporated into the product data in a number of ways. In some embodiments, the POS system (e.g., merchant terminal 140) may collect the product information as the items are being scanned and provide it to service provider terminal 110. In some embodiments, such as during online shopping, merchant terminal 140 may provide the product information to service provider terminal 110, for example, via a retailer's website associated with one or more merchants. In the event that the retailer's website is unable to provide product information, a browser plug-in may monitor items viewed or selected by user terminal 120 and provide the product information to service provider terminal 110. Other embodiments of a system according to the present disclosure may be associated with a financial service provider, such that product data 410 is collected from the records of the payment method and provided to service provider terminal 110 (e.g., via a financial service provider terminal, not shown).

Box 440 represents passive product information acquisition such as a sensor-based method. In some embodiments, a device may include sensors (e.g., RFID) that automatically identifies nearby products or products that pass through a predetermined area (e.g., pass through a checkout counter or are placed in a shopping cart). A system employing a passive sensor-based method may identify the products in a customer's cart or basket by determining which products are moving with the customer throughout the store. In some embodiments, a merchant may provide carts or baskets having sensors to detect which products are placed therein, and such sensors may be in communication with merchant terminal 140. In turn, merchant terminal 140 may automatically collect and pass along product data 410 associated with the identified products to service provider terminal 110.

Product data 410 can be collected automatically and/or manually, and be merchant-provided and/or customer-provided. In some embodiments, product data 410 may be a combination of multiple data sources, and in other embodiments it may be collected from a single source. Certain applications of complementary product suggestion system 100 may dictate the manner in which product data 410 is collected. For example, in a grocery store, because there are too many products to place RFID tags on each of them, a system deployed in a grocery store may employ a customer scanned or a merchant provided product data collection method. In an application designed for a consumer electronics retailer, particularly where anti-theft RFID tags may already be employed for loss prevention, an automatic sensor-based product data collection method may be readily employed.

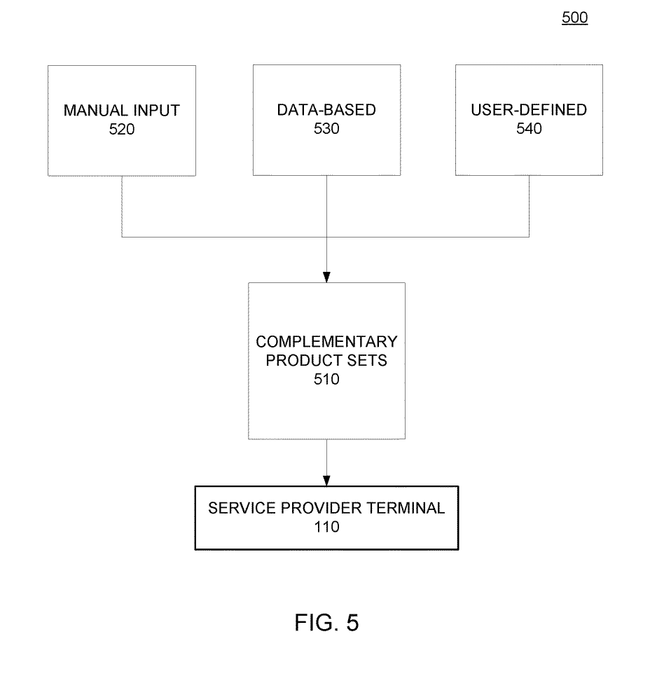

FIG. 5 shows a diagram that represents an embodiment of complementary product set acquisition system 500. As discussed above with regard to step 320, a purchased product listing may be compared to one or more predetermined sets of complementary products. These predetermined sets of complementary products may be stored in memory 230 of service provider terminal 110. As illustrated in FIG. 5, one or more complementary product sets 510 may be inputted manually as at 520, generated from data sets as at 530, and/or user defined as at 540.

Box 520 represents manual input of collections of complementary product sets. In some embodiments, these sets may be manually entered (e.g., via I/O device 220 of service provider terminal 110 or merchant terminal 140) by system administrators or a merchant based on common knowledge. For example, knowing that an outfit may comprise pants or a skirt, a shirt or blouse, and accessories such as belts, shoes, or jewelry, an administrator may include various sets based on these combinations. As another example, an administrator may input grocery product sets based on recipes from one or more cookbooks. In some embodiments, product manufacturers or retailer merchants may provide promotional complementary product sets, such as a video game console manufacturer providing a complementary product set that includes an additional controller or a new video game.

In some embodiments, complementary product sets 510 may be generated automatically based on consumer data sets as at box 530. Consumer purchasing habits may be monitored, and recommendations for complementary product sets 510 may be generated based automatically based on trends in consumer data. For example, if a certain percentage of consumers purchase a particular set of items or if a particular user has a history of purchasing a particular set of items at a single purchase event, that product set may be provided (e.g., via merchant terminal 140) to service provider terminal 110 for storage in memory 230. In some embodiments employing this system, the complementary product sets 510 may be dynamic and may be updated at regular intervals in order to provide accurate and up-to-date suggestions.

In addition to, or as an alternative to the manual system input or the data-based set generation, the user may be allowed to define their own complementary product sets 510 based on their habits or goals. For example, via user terminal 120, a user may select a goal (e.g., make a particular recipe or shop for an outfit for an event) such that the product set is defined similarly to a shopping list. Particularly when used in concert with one of the other sources for product sets 520 and 530, this method may ensure a user has the most complete shopping list, and is reminded if any items are omitted. In some embodiments, a user may use user terminal 120 to define a time interval for a product set (e.g., suggest milk when purchasing cereal, but only suggest milk every three weeks). This way the user can avoid unnecessary product recommendations based on, for example, individual consumption habits.

Each of these sets may be designed at a system level and may be generic to all users or may be specific to certain users based on demographic information. For example, a user that has identified a food allergy to a certain ingredient may not be suggested recipes including that ingredient. In another example, a user may identify themselves by a preferred style or clothing size, and as a result may have certain complementary product sets referenced. In other embodiments, a user may review and edit (e.g., via user terminal 120) complementary product sets provided by service provider terminal 110 and/or merchant terminal 140.

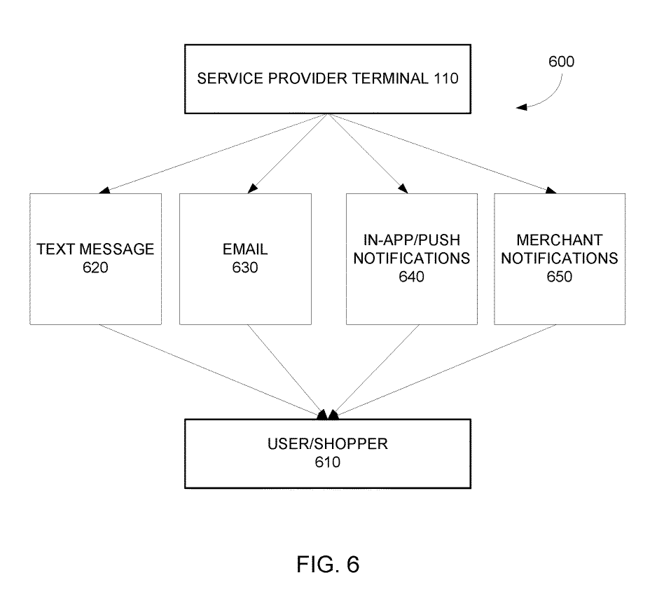

FIG. 6 shows a diagram that represents an embodiment of a notification system 600. As discussed above with regard to step 340, the system 100 may provide a notification of the one or more identified unpurchased complementary products to a computing device (e.g., user terminal 120 or merchant terminal 140). In some embodiments, service provider terminal 110 may be configured to send the notification in the form of a text message 620 or an email 630. In some embodiments that include a mobile application, service provider terminal 110 may trigger an in-app or push notification on a mobile device (e.g., user terminal 120 or merchant terminal 140). The goal of these notifications may be to alert a user of the unpurchased products or to prompt a merchant to offer the unpurchased products for sale.

These notifications may include information to identify the product or type of product that would complete the complementary product set, as well as, for example, specific information about how or where or at what price that item may be purchased. In some embodiments, the notification may include a link to an online retailer where the item may be purchased. In such embodiments, when the notification is received on user terminal 120, user terminal 120 may receive input to follow the provided link and purchase the item. In applications where the user's device (e.g., user terminal 120) includes GPS, the notification may include directions and/or contact information for a local retailer. The notification may also have price information for one or more complementary products to allow the user to comparison shop.

In some embodiments, the notification may not go directly to a user's device, but rather may be sent to merchant terminal 140 as at 650. Merchant notifications may be delivered to a POS system so that a cashier may prompt the shopper to alert them to an unpurchased complementary product, and give them an opportunity to add it to their current order. Merchant notifications may also be delivered to a marketing department for the associated retailer, so that the retailer may contact the shopper directly to offer a complementary product for sale. Retailers may elect to offer a discount on a complementary product or free delivery to encourage the shopper to complete the complementary product set.

A system in accordance with the present disclosure may store purchase information of a user such as payment or shipping information. Payment information may include credit card or banking information to allow a user to more easily complete purchases or orders of the identified unpurchased complementary products. Shipping information may include addresses, shipping speed preferences, and/or delivery instructions (e.g. leave package with doorman). The system may also be associated with a particular retailer or retailers. It may connect to a user's account with those retailers, enabling the placement of an order for identified unpurchased complementary products using payment and shipping information associated with a user's retailer account. By using this additional information, the system can simplify, expedite, and encourage a user to complete a complementary product set.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology are described above with reference to mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### Exemplary Use Cases

The following exemplary use case describes one example a typical user flow pattern. It is intended solely for explanatory purposes and not in limitation. The user may be shopping in a retail store for a variety of products. While moving through the store, the user may use their mobile device (e.g., user terminal 120 or a scanner/camera in communication therewith) to scan items as they are being placed in the user's shopping cart. As the items are being scanned, product data 410 can be sent to a central system (e.g., system 100) and compared with predetermined sets of complementary products.

As the system senses, using GPS or a user indication (e.g., via user terminal 120 or merchant terminal 140), that the user is going to check out, the system may send a notification to the user's mobile device. This notification may include suggestions for complementary products that the user may have forgotten, or that a user may not have known would be helpful. The user may then decide to purchase those items either at the same retailer, at another identified retailer (e.g., such as a retailer identified by the system 100 to be on typical path home based on GPS data of user terminal 120), or over the internet and have those items shipped home.

A more specific example of this would be as follows: a shopper goes to a home goods store to purchase home furnishings. Using a provided mobile application on a mobile computing device (e.g., user terminal 120), the shopper scans a lamp, a rug, and a framed picture as the items are placed in the shopper's cart. Before checking out of the store, the shopper can press a button in the application labeled “Preparing to Check Out.” At this point, the application provides the user with a notification: “Do you have light bulbs for your new lamp? Check out these LED light bulbs on sale in this store, or order these light bulbs for delivery within two days.”

After the shopper indicates that light bulbs have already been purchased for the lamp, the application may provide another notification: “Do you have a non-skid rug pad? Check out this correctly sized rug pad in aisle 12, or order this item from our partner retailer for next day delivery.” Quickly detouring from the cash register, the shopper can pick up the rug pad and scan it as it goes into the cart. Recognizing the set is complete, the application moves to its final notification: “Do you have the correct mounting hardware for that framed picture? Since it is weighs approximately four pounds, this wall anchor will support it. It is for sale at the hardware store 0.2 miles away from your current location for $5.99.” The shopper can then check out at the home goods store, make a trip to the hardware store nearby, and drive home knowing that they will not have to make a second trip before decorating their home.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system for providing complementary product suggestions, comprising:
one or more memory devices storing instructions; and
one or more processors configured to execute the instructions to:
receive product data comprising a listing of purchased products;
determine whether any of the purchased products on the listing correspond to one or more predetermined complementary product sets;
identify, for at least one of the purchased products corresponding to one or more of the predetermined complementary product sets, one or more unpurchased products from the one or more complementary product sets; and
provide, to a computing device, a notification of the one or more identified unpurchased products.

2. The system of claim 1, wherein the computing device is a mobile computing device.

3. The system of claim 2, wherein the instructions to receive the product data further cause the one or more processors to scan, via a scanner in communication with the computing device, a product code associated with one or more of the purchased products in the listing.

4. The system of claim 1, wherein the instructions to receive the product data further cause the one or more processors to receive the product data from a merchant computing device at a point-of-sale location.

5. The system of claim 1, wherein the one or more processors are also configured to execute the instructions to:
identify product purchase data related to at least one of the identified unpurchased products; and
provide, to the computing device, the product purchase data.

6. The system of claim 5, wherein the product purchase data comprises one or more of: merchant identification, merchant location, merchant web address, product price, product stock information, and product shipping information.

7. The system of claim 1, wherein the product data comprises the listing of purchased products corresponding to a single purchase event.

8. The system of claim 1, wherein the one or more processors are further configured to execute the instructions to provide, to a merchant computing device at a point-of-sale location, a notification of the one or more identified unpurchased products.

9. The system of claim 1, wherein the one or more processors are further configured to execute the instructions to receive the one or more complementary product sets from a merchant computing device.

10. The system of claim 1, wherein the one or more processors are further configured to execute the instructions to receive one or more purchase histories associated with a plurality of customers, and determine the one or more complementary product sets based on the one or more purchase histories.

11. The system of claim 1, wherein the one or more processors are further configured to execute the instructions to receive the one or more complementary product sets from a manual input component of the computing device.

12. A non-transitory computer-readable medium storing instructions that, when executed by one or more processors, cause a computer system to:
receive product data comprising a listing of purchased products;
determine whether any of the purchased products on the listing correspond to one or more predetermined complementary product sets;
identify, for at least one of the purchased products corresponding to one or more of the predetermined complementary product sets, one or more unpurchased products from the one or more complementary product sets; and
provide, to a computing device, a notification of the one or more identified unpurchased products.

13. The non-transitory computer-readable medium of claim 12, wherein the computing device is a mobile computing device.

14. The non-transitory computer-readable medium of claim 13, wherein the instructions to receive the product data further cause the mobile computing device to scan, via a scanner in communication with the mobile computing device, a product code associated with one or more of the purchased products in the listing.

15. The non-transitory computer-readable medium of claim 12, wherein the instructions to receive the product data further cause the computing device to receive the product data from a merchant computing device at a point-of-sale location.

16. The non-transitory computer-readable medium of claim 12, further storing instructions that, when executed by the one or more processors, cause the computing device to:
identify product purchase data related to at least one of the identified unpurchased products; and
provide, to the computing device, the product purchase data.

17. The non-transitory computer-readable medium of claim 16, wherein the product purchase data comprises one or more of: merchant identification, merchant location, merchant web address, product price, product stock information, and product shipping information.

18. A system for obtaining complementary product suggestions, comprising:
one or more memory devices storing instructions; and
one or more processors configured to execute the instructions to:
provide, via a mobile computing device, product data comprising a listing of purchased products;
receive, on the mobile computing device, a notification of one or more unpurchased products based on the provided product data, the notification comprising product purchase data associated with the one or more unpurchased products, wherein at least one of the purchased products on the listing correspond to one or more predetermined complementary product sets and the unpurchased products comprise any products in the one or more predetermined complementary product sets that do not correspond with the provided product data; and
purchase, via the mobile computing device, one or more of the unpurchased products based on the product purchase data.

19. The system of claim 18, wherein the instructions to provide the product data further cause the one or more processors to scan, via a scanner in communication with the mobile computing device, a product code associated with one or more of the purchased products in the listing.

20. The system of claim 18, wherein the one or more processors are further configured to execute the instructions to provide, via a manual input component of the mobile computing device, the one or more complementary product sets.
